(19) United States
(12) Patent Application Publication
(10) Pub. No.: US 2011/0145919 A1
(43) Pub. Date: Jun. 16, 2011

(54) METHOD AND APPARATUS FOR ENSURING CONSISTENT SYSTEM CONFIGURATION IN SECURE APPLICATIONS

(75) Inventors: David J. WHELIHAN, Framingham, MA (US); Paul BRADLEY, Cumberland, RI (US)

(73) Assignee: DAFCA, INC., Framingham, MA (US)

(21) Appl. No.: 12/903,882

(22) Filed: Oct. 13, 2010

Related U.S. Application Data
(60) Provisional application No. 61/251,249, filed on Oct. 13, 2009.

(51) Int. Cl. G06F 21/22; G06F 1/24; G06F 9/24

(52) U.S. Cl. 726/22; 713/100; 713/2

(57) ABSTRACT

In exemplary embodiments, methods and apparatuses for securing electronic devices against tampering or unauthorized modifications are presented herein. One or more system locks may be installed in the system at a location between two or more subsystems along a communications path. Each system lock may be associated with a particular subsystem. The system locks may monitor the state of the system, including transactions targeting associated subsystems, and the transactions and/or state of the system may be compared to known valid transactions and states. If the requested transaction or enacted system state differs from a known acceptable transaction or state, a notification may be generated and countermeasures may be enacted. In some embodiments, the system locks may be located in a system bus on an electronic device to ensure that software executed on the electronic device remains free of tampering.

### RELATED APPLICATIONS

The present application claims priority to U.S. Provisional Application Ser. No. 61/251,249, entitled “Method and Apparatus for Ensuring Consistent System Configuration in Secure Application” and filed on Oct. 13, 2009. The contents of the aforementioned application are incorporated herein by reference.

### BACKGROUND

Integrated circuits (ICs) and systems make up the backbone of today's information economy. As such, they are under constant attack from malware that would co-opt them and force them to perform in ways not intended by their designers, as well as by physical “hacks” that disable Digital Rights Management (DRM) functions and enable theft of valuable data. System designers put safeguards into place to attempt to guarantee that the systems are used properly, but a motivated attacker can often discover these safeguards and disable them via software or hardware manipulation.

A number of systems incorporate a programmable device such as a microprocessor to attain a combination of cost-effectiveness, flexibility, and upgradability. Frequently, the salient functionality of such a system is defined not by its chips, components, and circuit boards, but by the software and data that it loads and executes. Since the software and data are easily modified, even remotely, the entire system behavior can also be easily modified.

Systems with microprocessors generally start up and load a specialized piece of software code, called boot code, that initializes the system. This boot code lays the foundation for all subsequent code to execute. It defines the basic ways that the system runs and interacts with the world. It is, therefore, important to protect the boot code, because boot code underpins other, more advanced, authentication and verification methods used by applications that will subsequently run on the microprocessor. Boot code may be secured either by writing it into immutable Read Only Memory (ROM), or by computing a cryptographic hash of the entire boot code set. A cryptographic hash function is a deterministic procedure that takes an arbitrary block of data and returns a fixed-size bit string, the (cryptographic) hash value, such that an accidental or intentional change to the data changes the hash value. The data to be encoded is often called the “message” and the hash value is sometimes called the “message digest.” That digest is compared to a stored, known good value every time the system starts up, guaranteeing that the boot code has not changed. This comparison is the basis for “attestation,” in which an autonomous system element verifies the hash and vouches for the validity of the boot code. Note that once the boot code is attested, it can, in turn, attest to the validity of other software that has a cryptographic hash.

Thus, a chain-of-trust is established, and it is rooted in the lowest autonomous agent and the secrets it protects (the expected hash values).

Problematically, systems do not necessarily incorporate an autonomous root-of-trust. That is, the entity that attests to the boot code is not necessarily the entity that calculated the original hash values for the code and, as a result, the entity attesting to the boot code may need to rely on other (potentially untrustworthy) entities to perform attestation. For example, systems such as Trusted Platform Modules (TPMs)—which exist in a great many systems today and supply secure key and hash storage as well as cryptographic functions to compute them—are not generally autonomous because they do not perform the hash function on the boot code. Other parts of the system, which may themselves be vulnerable to attack, perform the hash function.

Furthermore, data upon which the boot code operates is not necessarily attested and verified. Data differs from code in that code is a function whose input is data, and (generally, though not always) more data is the result. The same piece of code executes differently (i.e., the outputs of the function it represents will be different) based on the data input. Sometimes data is stored with the code; in this case, cryptographic, hash-based attestation will work because the inputs and the function are attested. However, in most systems, especially those with legacy peripheral devices and interfaces that themselves supply configuration data, this is not the case. Some subsystems actually have Non-Volatile Random Access Memory (NVRAM) configuration storage that can be changed. Since the boot code is generally responsible for configuring and enabling these types of systems, one cannot guarantee that that the data inputs are attested. Therefore, one cannot guarantee that boot code, even if the code itself is attested, will function the same way every time.

Moreover, as system entropy grows, code attestation becomes less and less useful. Attestation can work well when a system is booting but it is, by its very nature, inflexible. This inflexibility renders attestation incomplete as a general-purpose solution due to its inability to verify data and to withstand code that modifies itself (so-called self-modifying code). As a system continues to run, small changes to the system state, whether code changes, upgrades, or data changes, can build up and the aggregate system entropy increases. The progression of a system toward higher entropy is due to the fact that the ordered state, the state that hash-based attestation is meant to verify, is not the most probable state of the system. Therefore, the system will probabilistically move toward a more chaotic (entropic) state.

### SUMMARY

The present application addresses the above shortcomings and others by providing methods and apparatuses for securing electronic devices against tampering or unauthorized modifications. In exemplary embodiments, a distributed set of hashing instruments are employed to verify that the configuration of a subsystem is unchanged from a known acceptable configuration.

In some embodiments, one or more system locks may be installed in the system at a location between two or more subsystems along a communications path. Each system lock may be associated with a particular subsystem. The system locks may be, for example, hash-lock instruments which compute a hash value based on information related to the system, such as the current system state or a transaction which the system is requesting to be performed. The apparatus may further include reporting hardware which stores predetermined identifiers of known acceptable system configurations and/or transactions. The system locks and reporting hardware may be autonomous and therefore may not depend on any configuration from the normal boot-code channel.

The system locks may monitor the state of the system, including transactions targeting associated subsystems. In some embodiments, the system locks may be located in a system bus on an electronic device to ensure that software executed on the electronic device remains free of tampering. The transactions and/or state of the system may be compared to known valid transactions and states as stored in the reporting hardware.

If the requested transaction or enacted system state differs from a known acceptable transaction or state, a notification may be generated and countermeasures may be enacted.

In some embodiments, a training mode is provided that allows for the expected system behavior to be recorded in a secure facility, such as the reporting hardware. The system locks and/or reporting hardware may be trained against a known valid system configuration, and one or more expected identifiers may be stored for comparison to future transactions and system states.

In one embodiment, a method for detecting changes in a system configuration is provided. The method may comprise executing one or more instructions using one or more electronic devices to effect a system configuration. An identifier that corresponds the system configuration is determined and compared to a predetermined expected identifier. If the determined identifier differs from the expected identifier, it may be determined that the system configuration has been changed to an invalid state, indicating that the system has been tampered with.

In some embodiments, the method may be performed in a tamper-resistant system comprising that participates in a transaction. One or more system locks associated with the subsystem may be provided. The system locks may receive one or more identifiable signals as a result of the transaction. Based on the signals, the transaction may be identified and determined to be a valid or invalid transaction. If the transaction is identified as invalid, the system locks may determine that the system has been modified or tampered with.

The instructions or transactions may be a part of a boot sequence, or may in some way effect a deterministic system configuration. In this way, the system can be expected to operate in the same way every time, so that if an unexpected transaction or system configuration arises it can be determined that the system has been modified or tampered with.

In some embodiments, the system configuration or transaction is identified by calculating a hash value of the transaction or system state. The hash value may be calculated by a hashing function that accepts one or more inputs comprising one or more parameters of the system configuration or transaction, and determines the hash value based on the one or more parameters. The hashing function may be performed using hardware located in a communication path between an accessing subsystem and a subsystem to be accessed.

The system configuration or transaction may be identified in a number of ways. For example, the system configuration or transaction may describe one or more characteristics of the electronic devices or subsystems which make up the tamper-resistant system, and the configuration or transaction may be identified based on the characteristics. The system configuration or transaction may also include data supplied by or received at the one or more electronic devices or subsystems, and may be identified based on the data. Further, the system configuration or transaction may be identified based on timing information related to the one or more electronic devices, subsystems, or transaction.

The system configuration may be measured at a predetermined system checkpoint. Further, executed transactions may be identified at the checkpoint.

### BRIEF DESCRIPTION OF DRAWINGS

FIG. 1 is a block diagram depicting an exemplary tamper-resistant system comprised of subsystems including a processor, memories, and peripheral devices, and system locks protecting the subsystems.

FIG. 2 is a block diagram describing one embodiment of a system lock.

FIG. 3 is a block diagram describing one embodiment of reporting hardware.

FIG. 4 is a flowchart describing an exemplary method for protecting a system from tampering.

FIG. 5 depicts exemplary system parameters whose values may be compared to predetermined acceptable values in order to determine whether a system has been modified.

FIG. 6 is a flowchart describing an exemplary method for training a temper-resistant system.

FIG. 7A is a timeline showing a first step in an example of a boot process in a hash-lock enabled system.

FIG. 7B depicts the transactions occurring in the hash-lock enabled system at time indicated in FIG. 7A.

FIG. 8A is a timeline showing a second step in an example of a boot process in a hash-lock enabled system.

FIG. 8B depicts the transactions occurring in the hash-lock enabled system at time indicated in FIG. 8A.

FIG. 9A is a timeline showing a third step in an example of a boot process in a hash-lock enabled system.

FIG. 9B depicts the transactions occurring in the hash-lock enabled system at time indicated in FIG. 9A.

FIG. 10A is a timeline showing a fourth step in an example of a boot process in a hash-lock enabled system.

FIG. 10B depicts the transactions occurring in the hash-lock enabled system at time indicated in FIG. 10A.

FIG. 11A is a timeline showing a fifth step in an example of a boot process in a hash-lock enabled system.

FIG. 11B depicts the transactions occurring in the hash-lock enabled system at time indicated in FIG. 11A.

FIG. 12A is a timeline showing a sixth step in an example of a boot process in a hash-lock enabled system.

FIG. 12B depicts the transactions occurring in the hash-lock enabled system at time indicated in FIG. 12A.

### DETAILED DESCRIPTION

Exemplary embodiments provide a method and apparatus to verify the proper initialization and/or configuration of a system by observing the configuration and data patterns to and from important subsystems. The data patterns can be recorded during a training process in which pervasive observation hardware (system locks) observes the characteristic effects of initializing various subsystems. Once the system is trained, each subsequent system initialization may cause the trained values to be compared against the presently observed values. These checks can be seamlessly integrated and correlated with the boot and initialization of system software, allowing for a checkpointing function that verifies that the system, in general, is configured in an appropriate or valid way on subsequent boots/initializations. Such a capability may allow the system to become tamper- or modification-resistant.

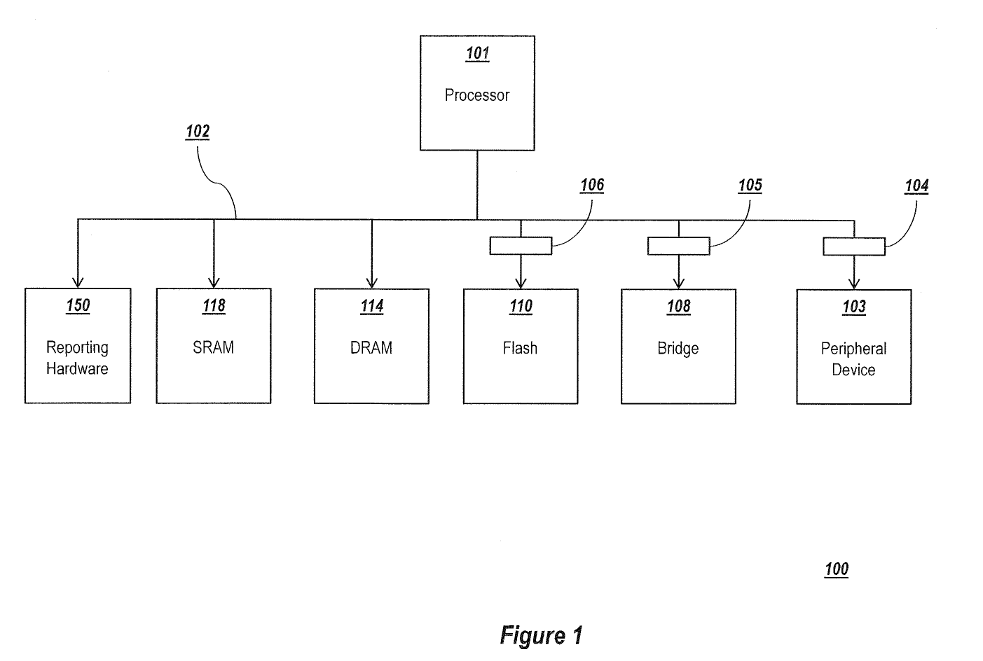

FIG. 1 is a block diagram depicting an exemplary tamper-resistant system 100 including a number of subsystems and system locks protecting the subsystems. The system 100 may, for example, represent a server, personal computer, laptop or even a battery-powered, pocket-sized, mobile computer such as a hand-held PC, personal digital assistant (PDA), or smart phone.

The system 100 includes a processor 101. The processor 101 may include hardware or software based logic to execute instructions on behalf of the system 100. In one implementation, the processor 101 may include one or more processors, such as a microprocessor. In one implementation, the processor 101 may include hardware, such as a digital signal processor (DSP), a field programmable gate array (FPGA), a Graphics Processing Unit (GPU), an application specific integrated circuit (ASIC), a general-purpose processor (GPP), etc., on which at least a part of applications can be executed. In another implementation, the processor 101 may include single or multiple cores for executing software stored in a memory, or other programs for controlling the system 100.

The present invention may be implemented on computers based upon different types of microprocessors, such as Intel microprocessors, the MIPS® family of microprocessors from the Silicon Graphics Corporation, the POWERPC® family of microprocessors from both the Motorola Corporation and the IBM Corporation, the PRECISION ARCHITECTURE® family of microprocessors from the Hewlett-Packard Company, the SPARC® family of microprocessors from the Sun Microsystems Corporation, or the ALPHA® family of microprocessors from the Compaq Computer Corporation.

The processor 101 may communicate via a system bus 102 to a peripheral device 103. A system bus 102 may be, for example, a subsystem that transfers data and/or instructions between other subsystems of the system 100. The system bus 102 may transmit signals along a communication path defined by the system bus 102 from one subsystem to another. These signals may describe transactions between the subsystems.

The system bus 102 may be parallel or serial. The system bus 102 may be internal to the system 100, or may be external. Examples of system buses 102 include, but are not limited to, Peripheral Component Interconnect (PIC) buses such as PCI Express, Advanced Technology Attachment (ATA) buses such as Serial ATA and Parallel ATA, HyperTransport, InfiniBand, Industry Standard Architecture (ISA) and Extended ISA (EISA), MicroChannel, S-100 Bus, SBus, High Performance Parallel Interface (HIPPI), General-Purpose Interface Bus (GPIB), Universal Serial Bus (USB), FireWire, Small Computer System Interface (SCSI), and the Personal Computer Memory Card International Association (PCMCIA) bus, among others.

In some embodiments, the system bus 102 may include a network interface. The network interface may allow the system 100 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 808 may include a built-in network adapter, network interface card, personal computer memory card international association (PCMCIA) network card, card bus network adapter, wireless network adapter, universal serial bus (USB) network adapter, modem or any other device suitable for interfacing the computing device 800 to any type of network capable of communication and performing the operations described herein.

The peripheral device 103 may include any number of devices which may communicate through the system bus 102. Examples of peripheral devices 103 include, but are not limited to: media access controllers (MACs) such as an Ethernet MAC; an input device, such as a keyboard, a multi-point touch interface, a pointing device (e.g., a mouse), a gyroscope, an accelerometer, a haptic device, a tactile device, a neural device, a microphone, or a camera; an output device, including a display device such as a computer monitor or LCD readout, an auditory output device such as speakers, or a printer; a storage device such as a hard-drive, CD-ROM or DVD, Zip Drive, tape drive, a secure storage device, or another suitable non-transitory computer readable storage medium capable of storing information, among other types of peripherals.

One or more system locks 104, 105, 106 sit on the bus interface 102 to the peripheral device 103, and take a fingerprint of all transactions that target the peripheral device 103. The system locks 104, 105, 106 may be small, distributed hardware and/or software elements that compute a digest of all accesses to critical system elements such as Ethernet Media Access Controllers (MACs) and secure memories. The system locks 104, 105, 106 may be consulted at one or more checkpoints in order to determine if the system is in the expected configuration at the time of the checkpoint. A checkpoint may be a predefined time at which the configuration of the system is verified. Alternatively, a checkpoint may be used to verify the system upon the occurrence of a predetermined event, such as a particular transaction.

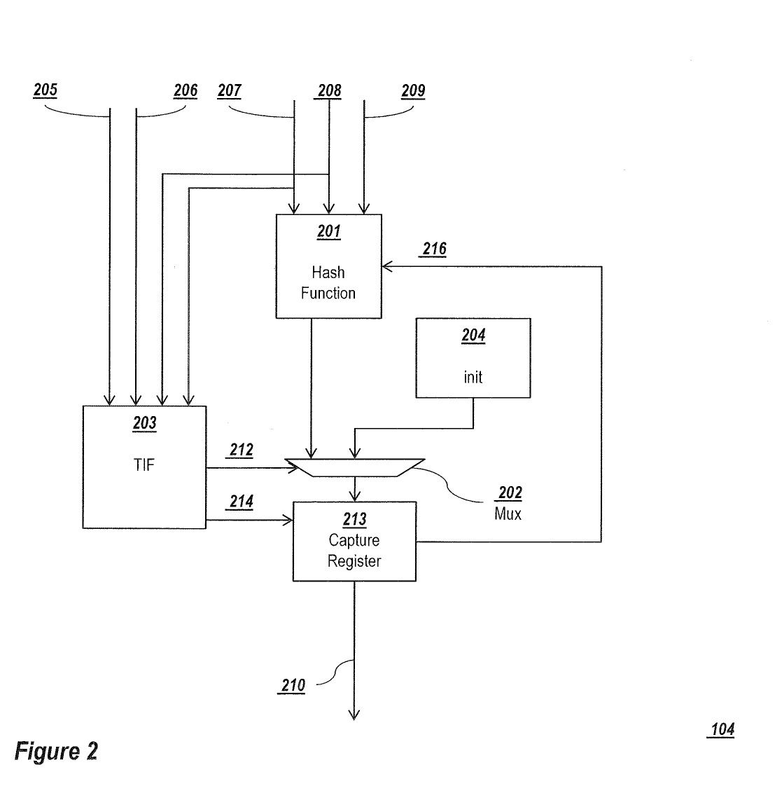

In one embodiment, one or more of the system locks 104, 105, 106 may be hash-based locks (referred to herein as hash-locks) which calculate one or more hash values for transactions that target the peripheral device or system configurations. The system locks 104, 105, 106 are described in more detail below with respect to FIG. 2.

The system 100 may further include one or more bridges 108, such as a Northbridge or Southbridge, for managing communications over the system bus 102 and implementing capabilities of a system motherboard.

The system 110 may include one or more types of memory, such as flash memory 110, Dynamic Random Access Memory (DRAM) 114, and Static Random Access Memory (SRAM) 118, among others.

The flash memory 110 may be non-volatile storage that can be electrically erased and reprogrammed. Flash memory 110 is used, for example, in solid state hard drives, USB flash drives, and memory cards. In some embodiments, the flash memory 110 may be read-only. In other embodiments, the flash memory 110 may allow for rewriting.

The DRAM 114 is a type of random access memory (RAM) that stores data using capacitors. Because capacitors may leak a charge, the DRAM 114 is typically refreshed periodically. In contrast, the SRAM 118 does not usually need to be refreshed.

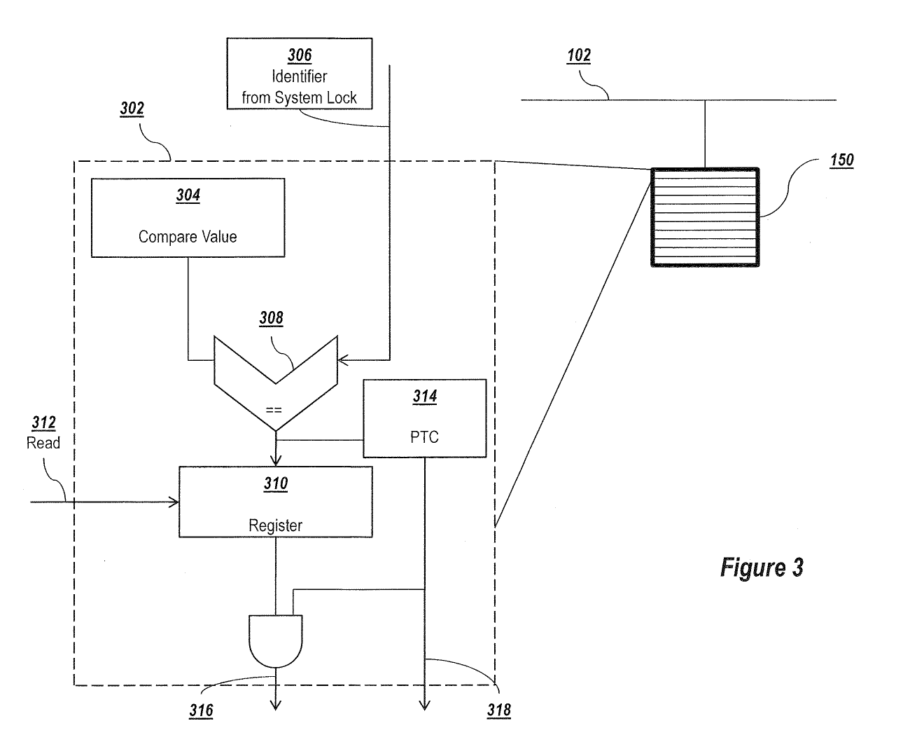

The system 100 may also include reporting hardware 150, which may be hardware and/or software that stores expected values for the identifiers and may compare the expected values to the identifiers as calculated by the system locks. In one embodiment, the reporting hardware 150 is a memory-mapped set of registers that provide a way to synchronize software execution, and therefore the boot process, with the calculated identifier. The reporting hardware may store information about known acceptable transactions and/or configurations in the system. The information stored in the reporting hardware 150 may be used in conjunction with the system locks 104, 105, 106 to protect the system 100 against tampering or modification. In some embodiments, the system locks 104, 105, 106 may calculate a hash value for a transaction or the state of the system, and the calculated has values may be compared to expected hash values stored in the reporting hardware 150. In this case, the reporting hardware 150 may be a hash board storing expected hash values. The reporting hardware 150 will be discussed in more detail below with respect to FIG. 3.

The system 100 can be running a Basic Input/Output system (BIOS) and/or an operating system (OS).

The Basic Input/Output System (BIOS) for the system 100 may be stored in the Flash Memory 110 and is loaded into the DRAM 114 upon booting. Those skilled in the art will recognize that the BIOS is a set of basic executable routines that have conventionally helped to transfer information between the computing resources within the system 100. The operating system or other software applications use these low-level service routines. In one embodiment, the system 100 includes a registry (not shown) that is a system database that holds configuration information for the system 100. For example, the Windows operating system by Microsoft Corporation of Redmond, Wash., maintains the registry in two hidden files, called USER.DAT and SYSTEM.DAT, located on a permanent storage device such as an internal disk.

In general, the OS executes software applications and carries out instructions issued by a user. For example, when the user wants to load a software application, the operating system interprets the instruction and causes the processor 101 to load the software application into the DRAM 114 and/or SRAM 118 from either the hard disk or the optical disk. Once one of the software applications is loaded into the RAM 114, 118, it can be used by the processor 101. In case of large software applications, the processor 101 loads various portions of program modules into the RAM 114, 118 as needed.

Examples of OSes include, but are not limited to the Microsoft® Windows® operating systems, the Unix and Linux operating systems, the MacOS® for Macintosh computers, an embedded operating system, such as the Symbian OS, Android, or iOS, a real-time operating system, an open source operating system, a proprietary operating system, operating systems for mobile computing devices, or other operating system capable of running on the computing device and performing the operations described herein. The operating system may be running in native mode or emulated mode.

The processor 101, system bus 102, peripheral device 103, bridge 108, flash memory 110, DRAM 114, and SRAM 118 each form a subsystem within the system 100. Each subsystem may participate in a transaction communicated over the system bus 102, which may involve one subsystem (the accessing subsystem) attempting to access or make changes to another subsystem (the accessed subsystem). As shown in FIG. 1, the system locks 104, 105, 106 may be located on the system bus 102 at a location between subsystems (for example, between an accessing subsystem and an accessed subsystem).

The system bus 102 may transmit one or more signals relating to the transaction, and the signals may pass through one or more of the system locks 104, 105, 106. As will be described in more detail below, the system locks 104, 105, 106 may identify the transaction or the state of the system 100, and determine whether the identified transaction or state is valid or invalid. In the event of an invalid transaction, the system 100 may be determined to have been tampered with or modified.

In other embodiments, the system locks 104, 105, 106 may observe the state of the system 100, and may compare observed state information to the expected state of the system as stored in the reporting hardware 150. If an unexpected system state is observed, the system 100 may be determined to have been tampered with or modified.

FIG. 2 is a block diagram describing one embodiment of a system lock 104. The exemplary system lock 104 employs a hash function 201 to hash a transaction or the current state of the system 100. A hash function is an algorithm or method that takes an input (sometimes referred to as a “key”) and calculates a value (sometimes referred to as a “hash” or “hash value”) corresponding to the input. The value may be used to identify the input. The calculated hash value may be compared to an expected hash value, for example a trained hash value stored in the reporting hardware 150.

The system lock 104 may be, for example, an instrument capable of calculating a hash value. The system lock 104 may be implemented using any hardware suitable for carrying out the functionality described.

The system lock 104 may include a hash function 201 that takes as input any uniquely identifying signals in a transaction, such as a system bus 102 transaction, or uniquely identifying features of the system 100 configuration. A hash function 201 operates on the inputs (known as “keys”) to calculate an identifier known as a hash value, which maps to the input. In the embodiment shown in FIG. 2, the hash function 201 receives information about a transaction on the system bus 102 requesting that certain data be written to a particular location in memory. Accordingly, the hash function 201 receives the write address 207, the data written 208, one or more byte enables 209, and the previous output of the hash function. The byte enables 209 qualify the data by specifying which bytes of the data are to be written. In general, any signal that uniquely characterizes a transaction on the interface may be included as an input to the hash function 201. The hash function 101 may calculate an output as a function of the inputs.

The hash function 201 should be robust and collision-resistant. Examples of suitable hash functions include, but are not limited to, the Bernstein hash algorithm, Fowler-Noll-Vo (FNV) hashing, the Jenkins hash function, Pearson hashing, and Zobrist hashing, among others.

The output of the hash function 201 may be fed to a capture register 202 that holds the output in the event that a valid transaction is identified by a Transaction Identification Function (TIF) 203. The capture register may be a memory element for storing calculated identifiers or hash values for later output (for example, to reporting hardware 150).

In one embodiment, the TIF 203 is a logic analysis function that monitors input signals and asserts output signals when specified transactions are detected. The TIF 203 is capable of identifying specific sequences of input signal transitions. For example, the TIF 203 may detect a read cycle to a specific memory address. Alternately, the TIF 203 may detect a specific data pattern on a databus, or the collective state of numerous control signals (e.g. reset, chip enable, output enable) from various subsystem circuits. In each case the TIF 203 may be configured to assert its output signal some time after the specific condition is detected. The TIF 203 determines the hash value computed by the system lock stored in the capture register 202 by controlling the Multiplexer select signal and the Capture Register 202 write enable. Note that the transaction may be repetitive and the value in the capture register 202 may be fed back to the Hash function block 201.

The TIF 203 may look for signal patterns and sequences over time in order to identify select points in time at which to compute the identifier. For example, the TIF 203 may use chip_select signals, read_enable signals, and/or write_enable signals in to identify a checkpoint (e.g., during the boot process). The TIF 203 takes some of the same signals that the hash function requires, such as the write address 207 and the data written 208, as well as signals a read enable signal 205 and a write enable signal 206. In general, the TIF 203 identifies that a transaction has occurred, while the calculated identifier indicates what the transaction is.

The system lock 104 may also have the capability to be preloaded with a particular initialization value 204. This initialization value 204 can be used to ensure that the calculated hash value ends at a particular implied value (e.g., 0) if the hash function is sufficiently simple, or it can be used to seed the hash for optimal security and collision-resistance. The hash value may also be preloaded with an initialization value that results in the hash output being a particular value (say, 0) after a set number of transactions.

A multiplexer 202 receives the results of the hash function 201 and a multiplexer select line 212 that controls which multiplexer inputs are sent through the multiplexer 202 outputs to the capture register 213. The capture register 213 also receives a capture register write_enable signal 214 from the TIF 203. The capture register 213 also provides the last hash value 216 to the hash function 201, to be used as an input during subsequent calculations.

The calculated hash value may be exported the reporting hardware 150 using the capture register output 210.

One or more embodiments of the system lock 104 may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

The system lock 104 depicted in FIG. 2 is only one example of a system lock which, in this particular instance, calculates a hash value. One of ordinary skill in the art will recognize that the transaction and/or system state need not necessarily be identified using a hash value. The identifier may be, for example, a checksum, check digit, data fingerprint, or error correcting code, among other possibilities.

FIG. 3 is a block diagram describing one embodiment of the reporting hardware 150. The reporting hardware 150 may be a memory-mapped interface that is accessible from the system's mission logic, that is, the logic that realizes the system's mission, whether it is decoding MP3s or flying an airplane. A reporting element 302 is a section of the system memory map that can be read with a bus transaction.

In one embodiment, the reporting element 302 supplies a data word that is the same width as the system's data bus. When read, that reporting element 302 will return at least a true/false value, and where appropriate, syndrome information to indicate what, if anything, went wrong. Those values are generated by comparing the expected value of a system lock 104 with the actual value returned from the system lock 104.

In one embodiment, this comparison is made on the first “read” to the element, and may not change subsequently. Thus, any access to the element must happen only once and at the exact right time relative to the configuration of the system. That is, the software access sequence can affect the behavior of the system lock 104 and/or the reporting hardware 150. For example, the system lock 104 can be designed such that an entry in the reporting hardware 150 can be accessed by the software only one time during a particular boot or initialization. If the entry is accessed at the right time, the reporting hardware 150 signals that the configuration is correct up to that point; otherwise, the reporting hardware 150 leaves the system in a “failed” state indefinitely.

One embodiment of the reporting hardware 150 is shown connected to the system bus 102 in FIG. 3. Each addressable location in the hash-board may contain a static compare value 304 that is the expected value of the identifier 306 when a transaction occurs on the system bus or the system state is determined at a checkpoint. The compare value 304 is compared to the identifier 306 that is input from the system lock 104. If a comparator 308 detects that the two values are equal, it outputs the value to a register 310, which captures and reports the value to the system bus 102 if a read 312 is initiated.

The reporting hardware 150 may also include a Pass-Through-Compare (PTC) circuit 314 that indicates whether the values were equal and then subsequently not equal, indicating that the read 312 either never happened or happened later than expected (after a subsequent write to the system lock). This value is latched indefinitely and results in the read value being false if the equal then not-equal condition is satisfied. This value can also be exported to a low-level security subsystem that can take action if necessary.

The reporting hardware 150 may output results to the system bus 102 on an output 316, and may further report results to a low level security subsystem on an output 318. In this way, if an invalid transaction or system state is detected, a notification may be generated and effective countermeasures can be enacted.

For example, during the initialization process the system software, including the boot code, can periodically access particular registers in the reporting hardware 150. If the access occurs when the system lock 104 is in the expected state (e.g., 0) then a success value is returned; else, a failure value is returned. On failure, the system software can halt or, if it has been somehow co-opted, a low-level security subsystem can enact countermeasures, such as system reset or lock-down, in response to a notification from the reporting hardware 150.

It is also important to note that the reporting hardware 150 itself can be protected by system locks 104. In that case, the value of the reporting hardware 150 “read” 312 is cleared from the hash input since including it would lead to a circular dependency between the current identifier, and its next state. If protected in this way, however, the result is a powerful “check-pointing of check-points.”

Moreover, the actual trained identifier need never be publicly available. Since it is trained by observation hardware that is not otherwise accessible to the main system hardware (e.g., the processor 101), the identifier, and therefore the access sequence required to “unlock” the system lock, can stay hidden and safe, eliminating an avenue of attack.

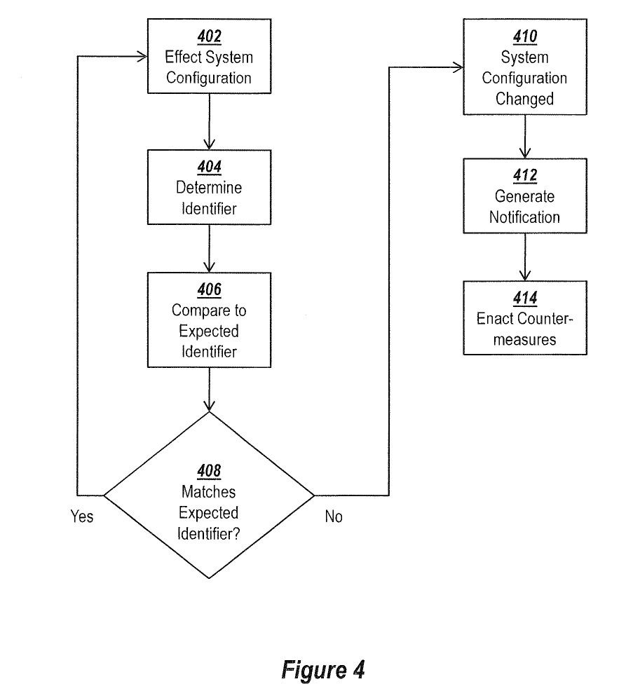

The system lock 104 and reporting hardware 150 can act together to protect a system from tampering. An exemplary protection method is described below with respect to FIG. 4.

FIG. 4 is a flowchart describing an exemplary method for detecting changes in a system configuration. The method may be performed using one or more electronic devices, such as the subsystems described above with respect to FIG. 1.

At step 402, a new system configuration may be effected. The system configuration refers to the configuration of the subsystems that make up the system, including the parameter values established for the subsystems. The system configuration may be effected by executing one or more instructions, which may be carried as transactions on the system bus 102. In some embodiments, the instructions may describe a boot sequence or an initialization sequence that initializes one or more subsystems.

The effected system configuration, instructions, and/or transactions may be deterministic. That is, the system may behave in a predictable, consistent manner such that the system always arrives at the same configuration given the same inputs, and/or executes the same instructions and transactions at the same time and in the same order for a given boot sequence or initialization process.

At step 404, an identifier is determined. The identifier may correspond to the effected system configuration. For example, the identifier may be calculated based on the transactions, instructions, and/or value changes that led to the effected system configuration.

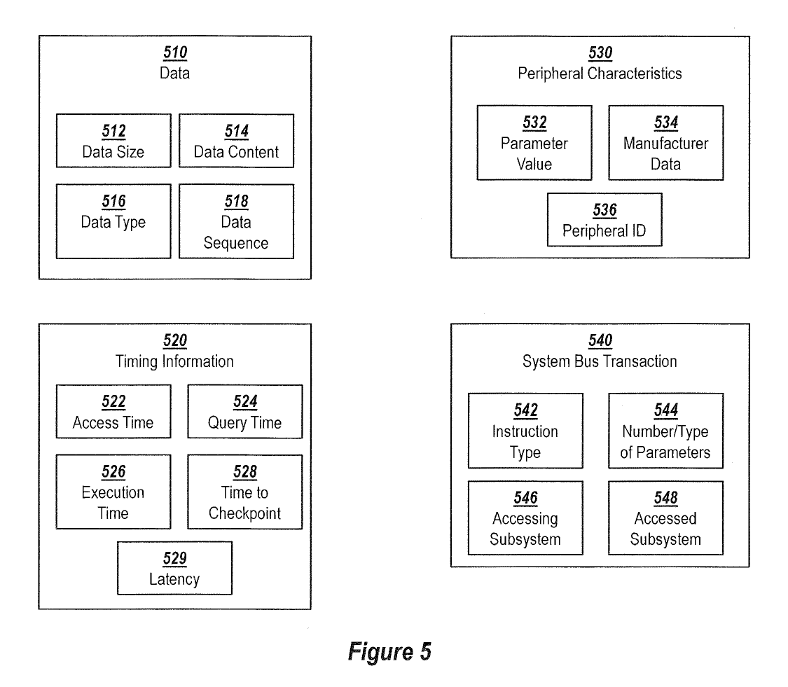

In one embodiment, the identifier may be a hash value generated by a hashing function. The hashing function may accept one or more inputs comprising one or more parameters of the system configuration, and may determine the hash value based on the one or more parameters. Parameters which may be employed to calculate an identifier are described in more detail below with respect to FIG. 5.

The hashing function, or the calculation of another type of identifier, may be performed using hardware located in a communication path between an accessing subsystem and a subsystem to be accessed. The accessing and accessed subsystems may be connected by a system bus 102, and the system configuration may comprise one or more identifying signals in a system bus transaction. For example, the system lock 104 may be used to calculate an identifier for a transaction between the processor 101 and the peripheral device 103.

The system configuration may be measured at a predetermined system checkpoint. For example, the system lock 104 may perform an ongoing process to calculate and update a hash value based on value changes observed at an associated subsystem (e.g., the peripheral device 103) until the system arrives at a checkpoint. Then, the system lock 104 may use the updated hash value as the identifier. The checkpoint may be identified, for example, based on an elapsed time, or the occurrence of a particular event, among other metrics.

At steps 406-408, the identifier is compared to the expected identifier and it is determined whether the calculated identifier matches the expected identifier. For example, the system lock 104 may send the calculated hash value to the reporting hardware 150, which may check the identified value against the stored, expected value, as described above with respect to FIG. 3.

The transaction, system configuration, and/or instructions may be determined to be either valid or invalid by comparing the identifier to the expected identifier. If, at step 408, it is determined that the identifier corresponds to the expected identifier (i.e., the system configuration has not been changed from the known or expected configuration), processing returns to step 402 and a new system configuration is effected.

If, on the other hand, at 408 the determination is “No,” processing proceeds to step 410, where it is determined that the system configuration has been changed. Subsequently, at step 412, a notification may be generated indicating that the system configuration has been modified or tampered with. The notification may be sent, for example, from the reporting hardware 150 to a low-level security subsystem that is tasked with ensuring the integrity of the system. At step 414, the low level security subsystem may enact countermeasures in response to the notification. For example, the security subsystem may cause the boot sequence to be stopped, may block access to certain subsystems, or may send a notification to a user, among other possibilities.

FIG. 5 depicts exemplary system parameters whose values may be compared to predetermined acceptable values in order to determine whether a system has been modified.

For example, the identifier may be calculated based on one or more properties of data 510 read and/or written by the system 100. Examples of data properties include the size 512 of the data to be read or written, the content 514 of the data, or the type of the data 516. In addition to individual units of data, the particular sequences of data 518 which occur in the system may be examined to calculate the identifier.

The identifier may also be calculated based on timing information 520. The timing information 520 may be measured, for example, by a system timer. The timing may be measured in absolute terms (e.g., elapsed time since boot or initialization) or in relative terms (e.g., the elapsed time since a previous event occurred).

The timing information 520 may include, for example, an access time 522, such as a read/write time at which data is read from or written to a subsystem. The timing information may further include the query time 524 at which one subsystem queries another subsystem for a status update. The timing information 520 may include the execution time 526 of one or more instructions on a subsystem, or the time 528 that it takes for the system 100 as a whole to reach a predetermined checkpoint. Further, the timing information may include latency times 529, which indicate the amount of time that elapses between specified events or transactions.

One or more characteristics 530 of the peripherals or subsystems may also be used to calculate the identifier. For example, if the subsystem includes one or more values for parameters (e.g., a particular memory subsystem is expected to have a particular value at a particular address at a particular time), the parameter value 532 may be used to calculate the identifier. Alternatively, data 534 regarding the manufacture of the peripheral, such as the make/model or manufacture date of the peripheral, may be used to calculate the identifier (thus helping to prevent one subsystem from being swapped for another subsystem). Alternatively, an ID 536, such as a serial number or MAC address, of a subsystem may be utilized.

If an identifier is calculated on the basis of a system bus transaction 540, the type of instruction 542 carried by the system bus (e.g., read/write transaction, query transaction, etc.) may be utilized to calculate the identifier. Alternatively, the number or type of parameters 544 which are used as an input or output to a method or function may be utilized, or the identity of the accessing subsystem 546 or the accessed subsystem 548 in the transaction may be used.

One of ordinary skill in the art will recognize that the above values which may be used to calculate the identifier are exemplary only, and that other possible values may equally be utilized.

Once it is determined which values will be used, the proper (i.e., expected) values for a check-pointed locking system can be trained into the system at a secure facility. This may be done, for example, by placing the reporting hardware 150 into a training mode that saves the current hash value on read, rather than comparing it.

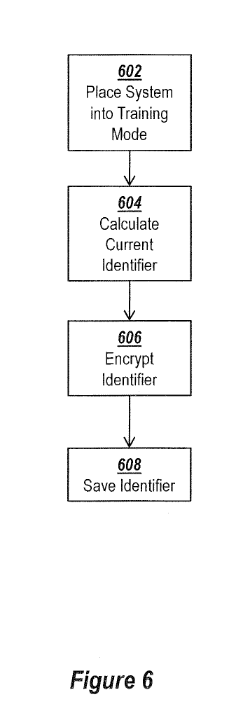

FIG. 6 is a flowchart describing an exemplary method for training a temper-resistant system. The process begins at step 602, when the system is placed into training mode. This may involve, for example, sending a control signal to the reporting hardware 150 instructing the reporting hardware 150 to record, rather than compare, observed identifier values. In some embodiments, the training mode is accessible only by a low-level security subsystem, thus preventing entry while the system is in the field. The training mode may be accessed when the system is in a known acceptable configuration, and/or may be accessed prior to issuing a number of “known good” transactions (e.g., transactions which will occur during a normal bootup or initialization.

At step 604, the system locks 104 calculate the currently observed identifier, as described above with respect to FIGS. 2 and 4. A series of reads to different subsystems scattered throughout the boot code may be used as a training signal. The system locks 104 pass the calculated identifiers to the reporting hardware 150, which optionally encrypts the identifiers at step 606.

At step 608, the reporting hardware 150 saves the observed identifiers as expected identifiers. These (potentially encrypted) expected identifiers may be saved in the system 100 or in non-volatile random access memory (NVRAM), or on separate hardware. In some embodiments, timing information is saved with the identifiers so that the reporting hardware 150 knows when the stored values are to be expected during a boot sequence or initialization.

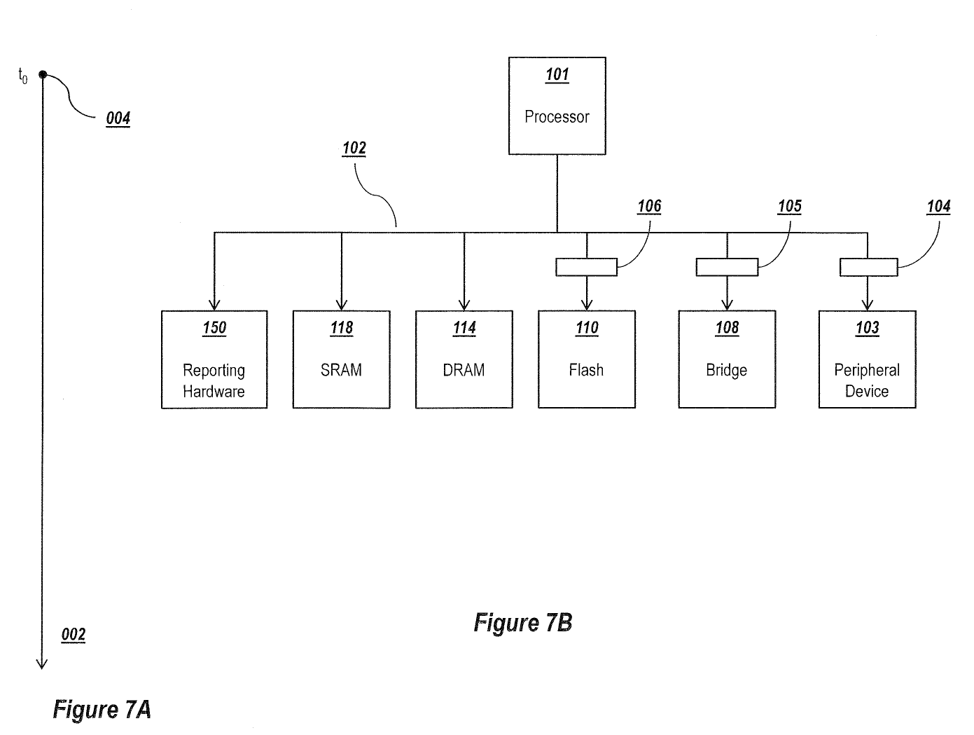

A specific example of a tamper-resistant system will now be described with respect to FIGS. 7A-12B. The examples described below are meant to be exemplary, and one of ordinary skill in the art will recognize that the invention described herein is not limited to the particular examples described.

FIG. 7A is a timeline 002 showing a first step in an example of a boot process in a hash-lock enabled system. As shown in FIG. 7A, the sequence begins at time t₀ (004), at which point the boot process is initiated. FIG. 7B depicts the state of the hash-lock enabled system at time indicated in FIG. 7A.

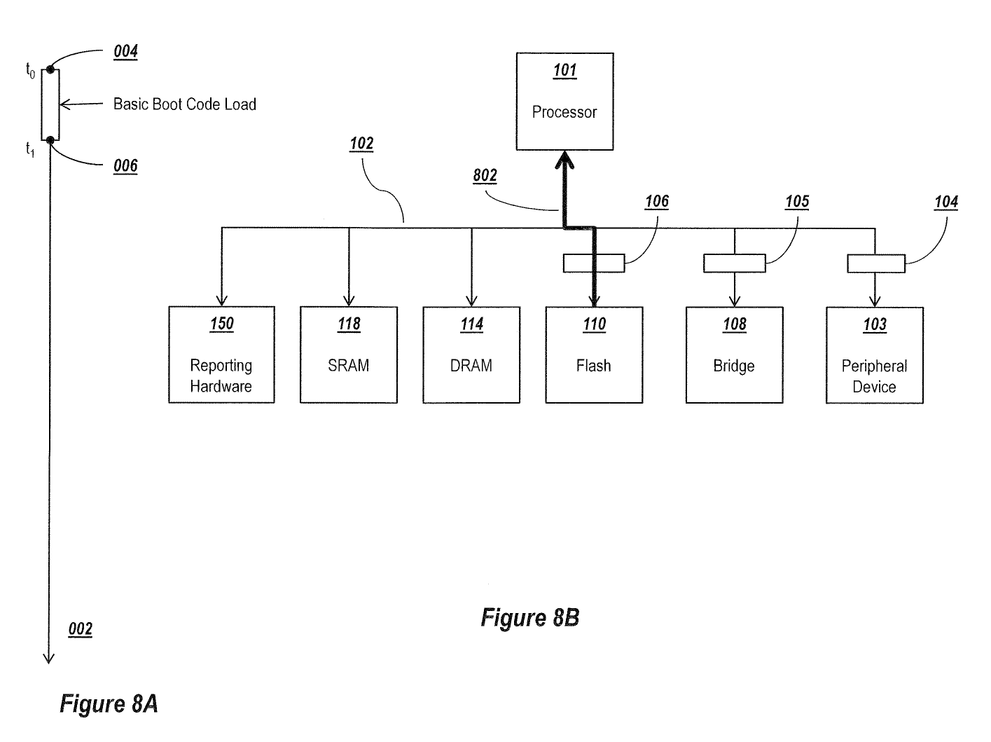

FIG. 8A is a timeline 002 showing a second step in an example of a boot process in a hash-lock enabled system. FIG. 8B depicts the transactions occurring in the hash-lock enabled system at time indicated in FIG. 8A. At time t₁ (006), the processor 101 reads 802 the boot code from flash memory 110 using the system bus 102.

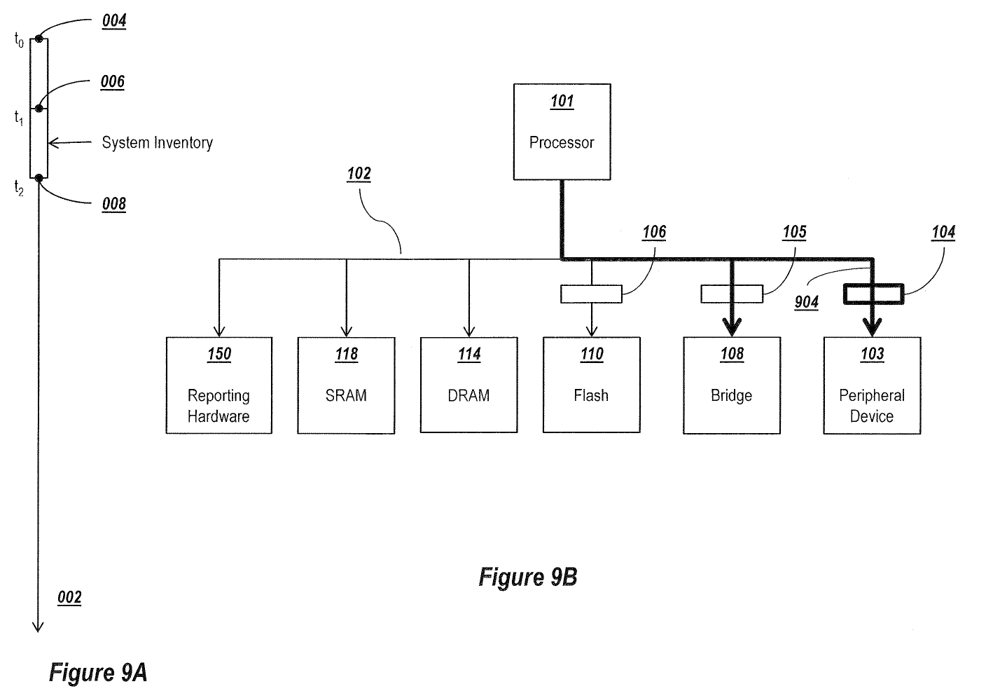

FIG. 9A is a timeline showing a third step in an example of a boot process in a hash-lock enabled system. FIG. 9B depicts the transactions occurring in the hash-lock enabled system at time indicated in FIG. 9A. As shown in FIGS. 9A-9B, at time t₂ (008), the boot code is executed by the processor 101, which queries the peripheral device 103 to determine the peripheral device 103's function and configuration.

The queries to the peripheral device 103 are detected by the system lock 104, and any read and write activity 904 is hashed with the initial hash value in the system lock 104. The recorded write and read activity can include the address read or written to, as well as the data that was accessed. This hashing of the data differentiates this approach from others in that the actual resultant configuration of the subsystem can be verified for consistency.

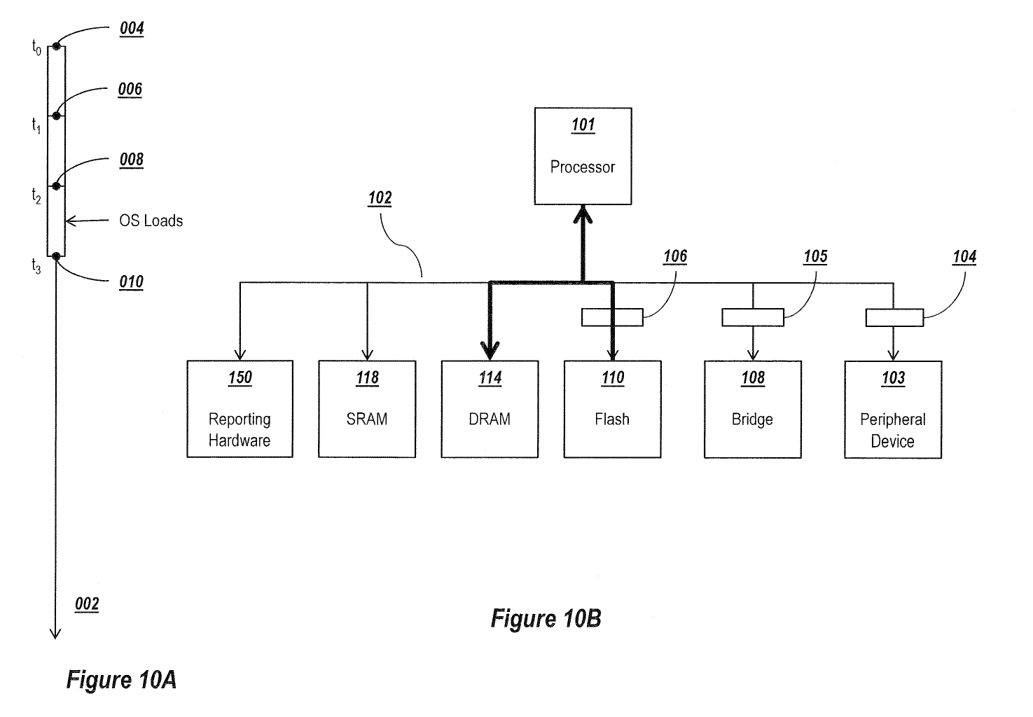

FIG. 10A is a timeline showing a fourth step in an example of a boot process in a hash-lock enabled system. FIG. 10B depicts the transactions occurring in the hash-lock enabled system at time indicated in FIG. 10A. At time t₃ (010), the processor 101 loads the operating system from the flash memory 110, configures the operating system, and loads portions of the operating system to be executed into the DRAM 114.

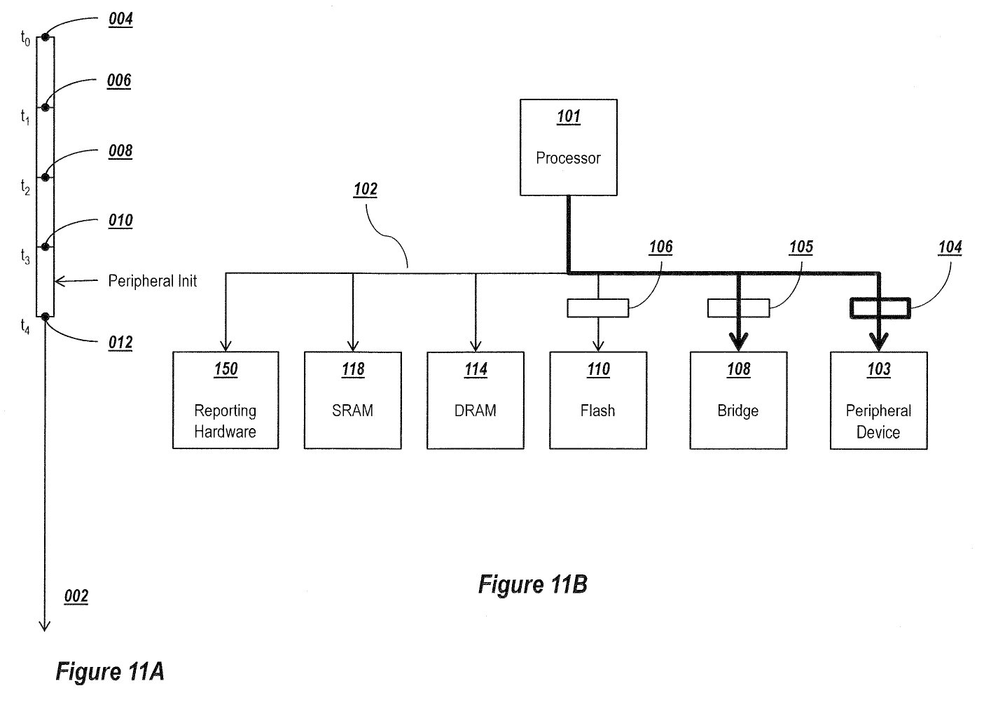

FIG. 11A is a timeline showing a fifth step in an example of a boot process in a hash-lock enabled system. FIG. 11B depicts the transactions occurring in the hash-lock enabled system at time indicated in FIG. 11A. At time t₄ (012), the processor 101 configures the peripheral device 103. This configuration access is detected by the system lock 104 and added to the running value in the local system lock 104.

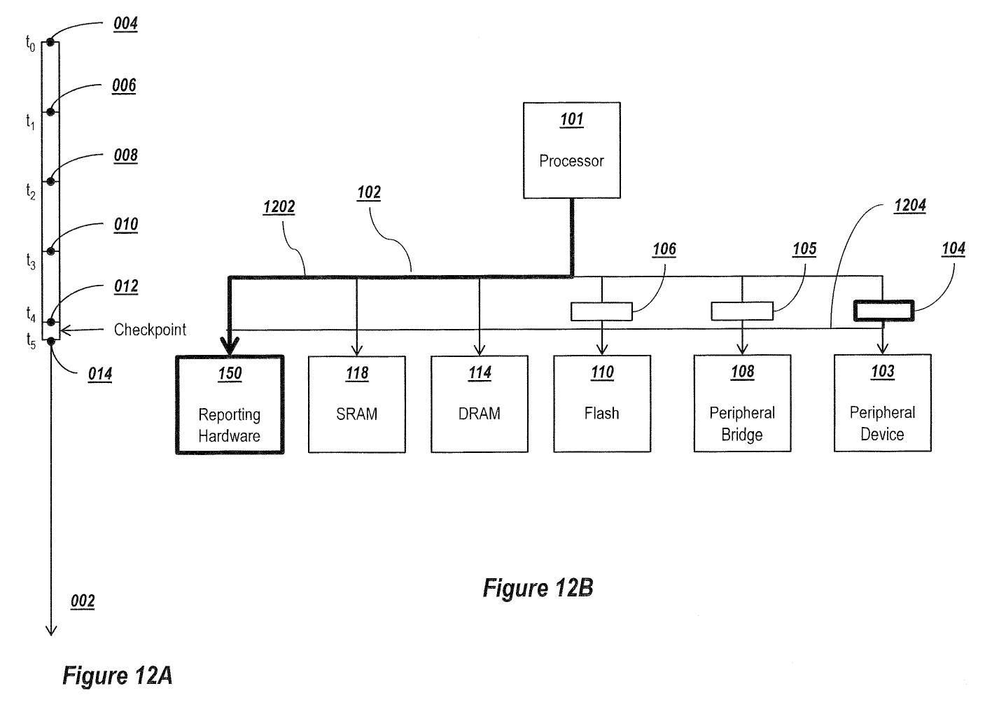

FIG. 12A is a timeline showing a sixth step in an example of a boot process in a hash-lock enabled system. FIG. 12B depicts the transactions occurring in the hash-lock enabled system at time indicated in FIG. 12A. At time t₅ (014), the system reaches a predetermined checkpoint. Accordingly, the system software running on the processor 101 accesses 1202 the reporting hardware 150 to check that the hash value is correct.

The system lock 104 reports 1204 the identifier calculated based on the transactions occurring at times t₀-t₅ to the reporting hardware 150. The reporting hardware 150 compares the identifier calculated by the system lock 104 with the expected value and reports success or failure. In some embodiments, the expected value is never released from the reporting hardware/system lock subsystem, preventing manipulation of the value by changing data patterns on the system bus 102.

In summary, the present invention provides a check-pointing capability to verify proper software configuration using system hardware. Because the system locks of the present invention may be distributed to even the smallest system element, they can provide configuration security long after system initialization since they are less susceptible to increased system entropy. The invention observes not just address access characteristics, but also the data itself, thus allowing for a generalizable checkpointing scheme.

The invention has been described in terms of particular embodiments. Other embodiments are within the scope of the following claims. For example, the steps of the invention can be performed in a different order and still achieve desirable results. This application is intended to cover any adaptation or variation of the present invention. It is intended that this invention be limited only by the claims and equivalents thereof.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, a computing device (e.g., a workstation) or a user of a computing device, unless otherwise stated.

The scope of the invention is defined by the claims and their equivalents.

1. A method for detecting changes in a system configuration, the method performed using one or more electronic devices and comprising:
executing one or more instructions using the one or more electronic devices to effect a system configuration;
determining an identifier associated with the system configuration;
comparing the determined identifier to a predetermined expected identifier; and
determining that the system configuration is changed when the determined identifier differs from the expected identifier.

2. The method of claim 1, wherein executing the one or more instructions effects a deterministic system configuration

3. The method of claim 2, wherein the one or more instructions describe a boot sequence of the one or more electronic devices.

4. The method of claim 1, wherein the determined identifier is a hash value generated by a hashing function.

5. The method of claim 4, wherein the hashing function accepts one or more inputs comprising one or more parameters of the system configuration and determines the hash value based on the one or more parameters.

6. The method of claim 4, wherein the hashing function is performed using hardware located in a communication path between an accessing subsystem and a subsystem to be accessed.

7. The method of claim 1, wherein the system configuration comprises one or more characteristics of the one or more electronic devices.

8. The method of claim 1, wherein the system configuration comprises data supplied by or received at the one or more electronic devices.

9. The method of claim 1, wherein the system configuration comprises timing information related to the one or more electronic devices.

10. The method of claim 1, wherein the one or more electronic devices are connected by a system bus, and the system configuration comprises one or more identifying signals in a system bus transaction.

11. The method of claim 1, wherein the predetermined expected identifier are established by observing electronic devices in a configuration known to be an acceptable system configuration.

12. The method of claim 1, wherein the system configuration is measured at a predetermined system checkpoint.

13. The method of claim 1, further comprising generating a notification when it is determined that the system configuration has been changed.

14. The method of claim 13, further comprising enacting one or more countermeasures in response to the notification.

15. A tamper-resistant system, comprising:
a subsystem performing mission logic functions, the subsystem comprising one or more electronic devices participating in a transaction;
one or more system locks for securing the subsystem, the mission locks associated with the subsystem and receiving one or more signals as a result of the transaction, wherein:
the transaction is identified based on the signals; and
the identified transaction is determined to be either valid or invalid, and if the transaction is determined to be invalid, then the system is deemed to have been modified.

16. The system of claim 15, wherein the system lock determines a hash value for the transaction by applying a hash function in order to identify the transaction.

17. The system of claim 16, wherein the identified transaction is determined to be either valid or invalid by comparing the hash value to an expected hash value, wherein if the hash value matches the expected has value, the transaction is determined to be valid, and if the hash value does not match the expected hash value, the transaction is determined to be invalid.

18. The system of claim 17, further comprising a hash board storing the expected hash value.

19. The system of claim 15, further comprising a system bus connecting the subsystem to a second subsystem, wherein the transaction is communicated using the system bus and the system lock is located on the system bus between the subsystem and the second subsystem.

20. The system of claim 15, wherein the transaction effects a deterministic system configuration.

21. The system of claim 20, wherein the transaction occurs as part of a boot sequence of the system.

22. The system of claim 15, wherein the transaction is identified at least in part based on data supplied by or received at the subsystem.

23. The system of claim 15, wherein the transaction is identified based on timing information related to the transaction.

24. The system of claim 15, wherein the system comprises one or more stored instructions for placing the system lock in a training mode for observing the subsystem in a configuration known to be acceptable.

25. The system of claim 15, wherein the transaction is identified at a predetermined system checkpoint.

26. The system of claim 15, wherein a notification is generated when the one or more system locks determine that the system has been modified.

27. The system of claim 26, wherein the system enacts one or more countermeasures in response to the notification.

28. The system of claim 15, wherein the subsystem comprises a processor.

29. The system of claim 15, wherein the subsystem comprises a system bus.

30. The system of claim 15, wherein the subsystem comprises a peripheral device.
